(19) United States
(12) Patent Application Publication
(10) Pub. No.: US 2025/0390547 A1
(43) Pub. Date: Dec. 25, 2025

(54) INFORMATION PROCESSING APPARATUS

(71) Applicant: NEC Corporation, Tokyo (JP)

(72) Inventors: Ryuta MATSUNO, Tokyo (JP); Keita SAKUMA, Tokyo (JP); Masakazu HIROKAWA, Tokyo (JP)

(73) Assignee: NEC Corporation, Tokyo (JP)

(21) Appl. No.: 19/233,210

(22) Filed: Jun. 10, 2025

(30) Foreign Application Priority Data
Jun. 19, 2024 (JP) 2024-098727

(51) Int. Cl. G06F 17/11

(52) U.S. Cl. CPC G06F 17/11

(57) ABSTRACT

An information processing apparatus of the present disclosure includes: an acquiring unit configured to acquire first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and a generating unit configured to generate a second model in accordance with information representing a correspondence relation between the explanatory variable of the first data based on the classification and the first model, the second model for decision making predicting the first model corresponding to the explanatory variable.

### INCORPORATION BY REFERENCE

This application is based upon and claims the benefit of priority from Japanese patent application No. 2024-098727, filed on Jun. 19, 2024, the disclosure of which is incorporated herein in its entirety by reference.

### TECHNICAL FIELD

The present disclosure relates to an information processing apparatus.

### BACKGROUND ART

It is practiced in various fields to make a prediction for input data using a machine learning model. On the other hand, the prediction precision of a machine learning model may lower due to a change in data characteristic over time (concept drift). In such a case, as described in Patent Literature 1, it may be practiced to retrain a machine learning model.

### CITATION LIST

### Patent Literature

[Patent Literature 1] Japanese Unexamined Patent Application Publication No. JP-A 2023-170458

### SUMMARY OF INVENTION

### Technical Problem

However, when a machine learning model is retrained, the past data or model cannot be used. As a result, there arises a problem that it is not possible to apply a machine learning model to every situation and it is difficult to achieve increase of the prediction precision.

Accordingly, an object of the present disclosure is to solve the abovementioned problem that it is difficult to achieve increase of the precision of prediction using a machine learning model.

### Solution to Problem

An information processing apparatus as an aspect of the present disclosure includes: an acquiring unit configured to acquire first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and a generating unit configured to generate a second model in accordance with information representing a correspondence relation between the explanatory variable of the first data based on the classification and the first model, the second model predicting the first model corresponding to the explanatory variable.

Further, an information processing method as an aspect of the present disclosure includes: acquiring first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and generating a second model in accordance with information representing a correspondence relation between the explanatory variable of the first data based on the classification and the first model, the second model predicting the first model corresponding to the explanatory variable.

Further, a program as an aspect of the present disclosure includes instructions for causing a computer to execute processes to: acquire first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and generate a second model in accordance with information representing a correspondence relation between the explanatory variable of the first data based on the classification and the first model, the second model predicting the first model corresponding to the explanatory variable.

### Advantageous Effects of Invention

With the configurations as described above, the present disclosure can achieve increase of the precision of prediction using a machine learning model.

### BRIEF DESCRIPTION OF DRAWINGS

FIG. 1 is a block diagram showing an example of a configuration of an information processing apparatus according to the present disclosure.

FIG. 2 is a diagram showing an example of a state of processing by the information processing apparatus according to the present disclosure.

FIG. 3 is a diagram showing an example of a state of processing by the information processing apparatus according to the present disclosure.

FIG. 4 is a diagram showing an example of a state of processing by the information processing apparatus according to the present disclosure.

FIG. 5 is a diagram showing an example of a state of processing by the information processing apparatus according to the present disclosure.

FIG. 6 is a flowchart showing an example of processing operation of the information processing apparatus according to the present disclosure.

FIG. 7 is a block diagram showing an example of a configuration of an information processing system according to the present disclosure and a state of processing by the information processing system.

FIG. 8 is a diagram showing an example of a state of processing by the information processing system according to the present disclosure.

FIG. 9 is a block diagram showing an example of a hardware configuration of an information processing apparatus according to the present disclosure.

FIG. 10 is a block diagram showing an example of a configuration of the information processing apparatus according to the present disclosure.

### EXAMPLE EMBODIMENTS

### First Example Embodiment

A first example embodiment of the present disclosure will be described with reference to the drawings. The drawings may be related to any example embodiment.

An information processing apparatus 10 according to this example embodiment creates a prediction model that makes a prediction by performing machine learning, and makes a prediction for input data using the prediction model. In particular, in this example embodiment, the information processing apparatus creates prediction models for respective classifications obtained by classifying input data, and also creates a gate model that predicts an appropriate prediction model for the input data among the prediction models. Consequently, it is possible to make a prediction using an appropriate prediction model for input data, thereby achieving increase of the precision of prediction.

Here, as an example of a target of prediction by a prediction model, the presence or absence of occurrence of an attack, which is a patient's disease, and the probability of the occurrence will be given. In this case, as an explanatory variable, which is input data, biological information such as the body temperature and heart rate of a patient, time, and environmental information such as temperature and weather are given. When these are input into the prediction model, the presence or absence of the occurrence of the attack and the occurrence probability are predicted as a prediction value. At this time, as will be described later, a plurality of prediction models are previously created for respective characteristics of training data, which is patient data collected in advance, and furthermore, a gate model that predicts an appropriate prediction model for the patient's condition is previously created. Consequently, by inputting the patient's condition into the gate model, it is possible to predict the presence or absence of the occurrence of the attack and the occurrence probability using an appropriate prediction model for the patient's condition, and it is possible to increase the prediction precision. However, the target of prediction by the prediction model in the present disclosure is not limited to the abovementioned one and may be of any content.

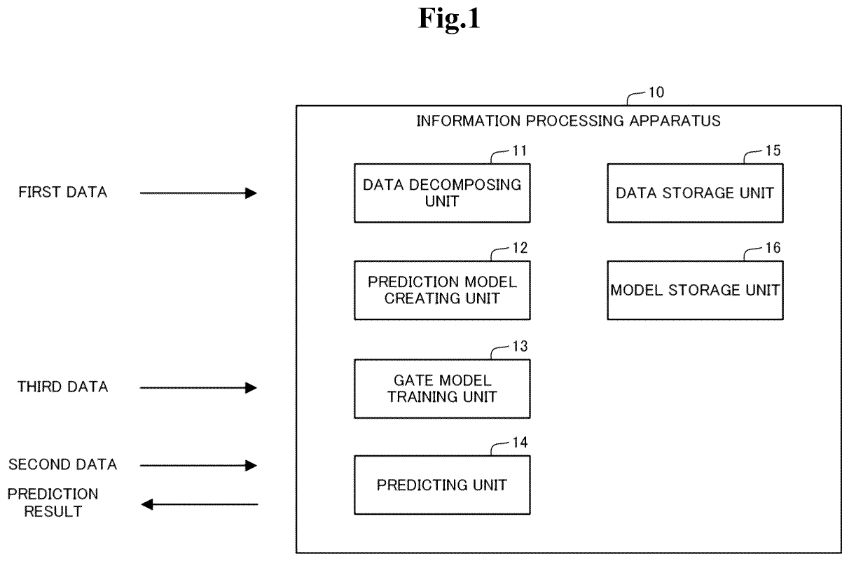

Below, the configuration and operation of the information processing apparatus 10 in this example embodiment will be described. The information processing apparatus 10 is configured with one or a plurality of information processing apparatuses each including an arithmetic logic unit and a memory unit. Then, as shown in FIG. 1, the information processing apparatus 10 includes a data decomposing unit 11, a prediction model creating unit 12, a gate model training unit 13, and a predicting unit 14. The respective functions of the data decomposing unit 11, the prediction model creating unit 12, the gate model training unit 13, and the predicting unit 14 can be implemented by execution of a program for implementing the respective functions stored in the memory unit by the arithmetic logic unit. The information processing apparatus 10 also includes a data storage unit 15 and a model storage unit 16. The data storage unit 15 and the model storage unit 16 are configured with the memory unit.

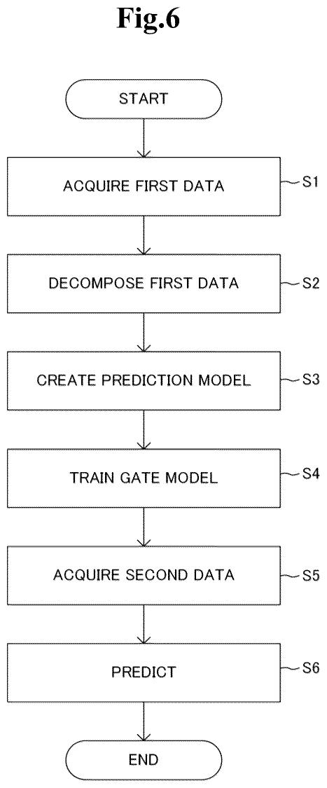

The data decomposing unit 11 (acquiring unit, classifying unit) first receives input of first data D1 as training data and stores it into the data storage unit 15 (Step S1 of FIG. 6). The first data D1 is composed of a data group including a plurality of pair data, each of which is composed of a pair of explanatory variable and objective variable and serves as one unit. The first data D1 is data, for example, obtained from actual examples or generated from simulation, a probability model or the like. In the abovementioned case of predicting the occurrence of the patient's attack, the first data D1 is composed of a pair data group obtained by collecting a number of pair data each including an explanatory variable composed of the patient's biological data and environmental information measured at a time in the past and an objective variable composed of the presence or absence of the occurrence of the attack and the occurrence probability within a predetermined time after the time. For example, the first data D1 can be expressed as Formula 1 below with an explanatory variable as x and an objective variable as y.

$${D}_{1} = {\{ ( {x}_{i} , {y}_{i} ) \}}_{i = 1}^{{m}_{1}} \qquad [ Formula 1 ]$$

Then, the data decomposing unit 11 decomposes the first data D1 into pieces of sub data B based on the correspondence relation between the explanatory variable x and the objective variable y (Step S2 of FIG. 6). That is to say, the data decomposing unit 11 classifies the first data D1 into a plurality of pieces of sub data, namely, classifications by including pieces of pair data with common characteristic into the same piece of sub data B in accordance with the characteristic of the pair data including the explanatory variable x and the objective variable y. As an example, the data decomposing unit 11 decomposes the first data D1 into sub data B₁, B₂, . . . , Bₖ, that is, K pieces of sub data Bk as shown by Formula 2 below.

$${B}_{k} = {\{ ( {x}_{ki} , {y}_{ki} ) \}}_{i = 1}^{{n}_{k}} \qquad [ Formula 2 ]$$

The number K of sub data to decompose the first data D1 may be a parameter designated by the user or may be a parameter set in advance.

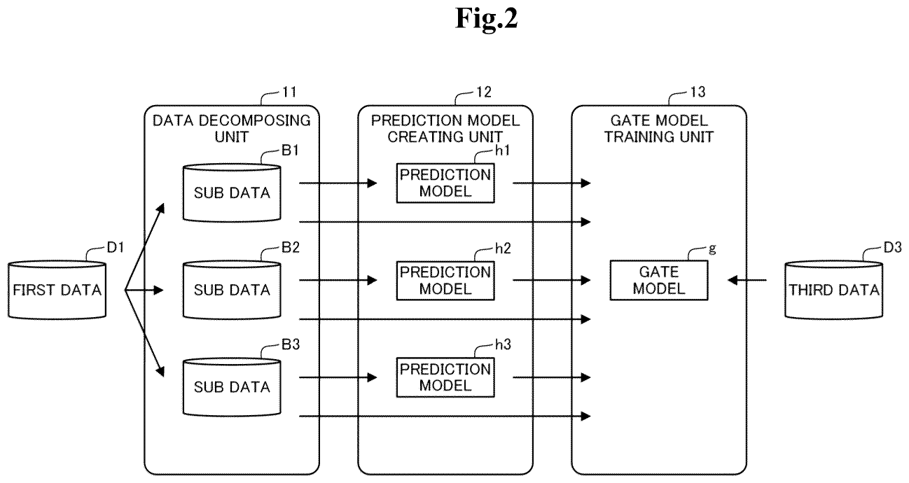

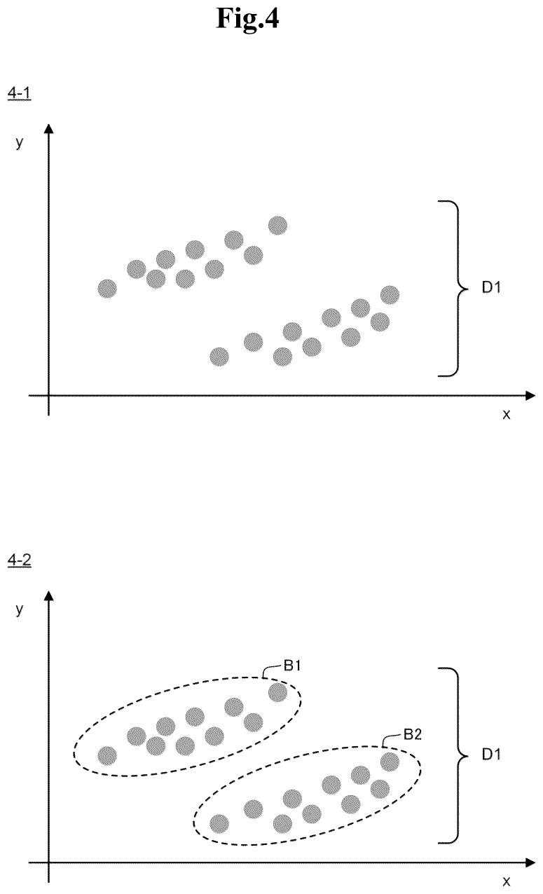

To be specific, the data decomposing unit 11 decomposes the first data D1 into a plurality of pieces of sub data B with different correspondence relations between explanatory variable x and objective variable y by a clustering method such as the K-means method and the shortest distance method. For example, the data decomposing unit 11 decomposes the first data D1 into three sub data B1, B2 and B3 as shown in FIG. 2, and decomposes the first data D1 as shown in FIG. 4(4-1) into two sub data B1 and B2 as shown in FIG. 4(4-2). In FIG. 4, one circle mark is assumed to correspond to one pair data composed of a pair of explanatory variable x and objective variable y.

When decomposing the first data D1 into the sub data B, the data decomposing unit 11 may include one pair data composed of a pair of explanatory variable x and objective variable y into a plurality of sub data B, respectively. At this time, the data decomposing unit 11 may decompose in such a manner as to give a weight corresponding to each of the sub data B to one pair data and include the pair data into each of the sub data B. For example, in the case of dividing into two sub data B1 and B2 as shown in FIG. 4(4-2), the data decomposing unit may decompose in such a manner as to give specific pair data a weight 0.7 for the sub data B1 and a weight 0.3 for the sub data B2 and include the specific pair data into both the sub data B1 and B2. At this time, the sub data B can be expressed as Formula 3 using a weight w. One pair data does not need to be decomposed in such a manner as to be included in at least one sub data B, and may be included in no sub data B.

$${B}_{k} = {\{ ( {x}_{i} , {y}_{i ,} {w}_{ki} ) \}}_{i = 1}^{{m}_{1}} \qquad [ Formula 3 ]$$

The data decomposing unit 11 may, along with creating a prediction model h and training a gate model g to be described later, repeatedly perform the process of decomposing the first data D1, which will be described later.

The prediction model creating unit 12 (acquiring unit, first model generating unit) creates, for each of the sub data B obtained by decomposing the first data D1 as described above, a prediction model h (first model) that predicts an objective variable y from an explanatory variable x using pair data included in the sub data B, and stores it into the model storage unit 16 (Step S3 of FIG. 6). Specifically, for each of the sub data B, the prediction model creating unit 12 sets pair data of explanatory variable x and objective variable y included in the sub data B as training data, and performs machine learning on a prediction model h in such a manner as to minimize the error between a prediction value when the explanatory variable x is input into the prediction model h and the objective variable y paired with the explanatory variable x. As the prediction model h, for example, a decision tree, a neural network, a gradient boosting model, and the like may be used. Consequently, each prediction model h is configured to receive input of a new explanatory variable x such as second data D2 as will be described later and output a prediction value that can be an objective variable y for the explanatory variable x.

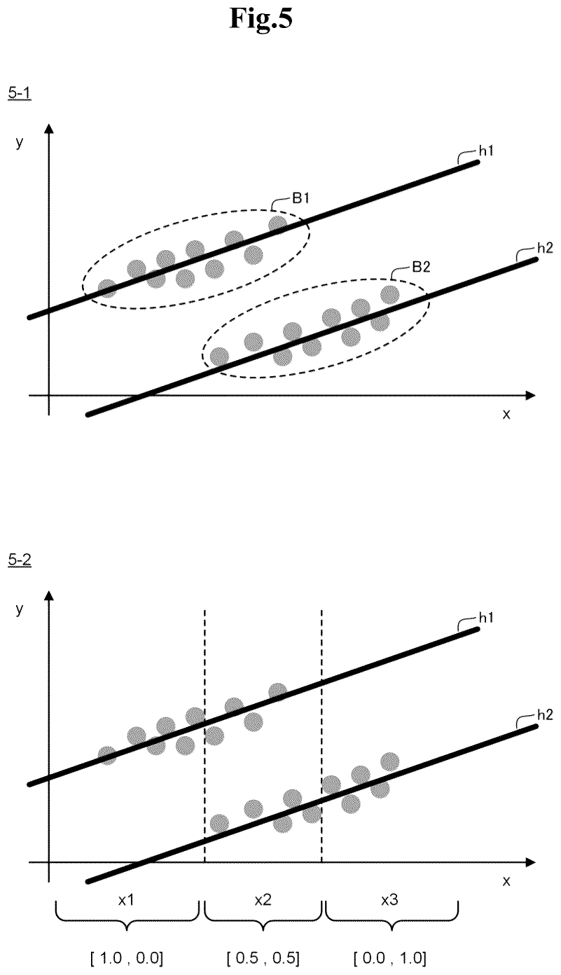

For example, in a case where the first data D1 is decomposed into K pieces of sub data B as described above, the prediction model creating unit 12 creates K prediction models h₁, . . . , h_{K} corresponding to the K pieces of sub data B, respectively, and a prediction value by such a prediction model hₖ is expressed by hₖ(x). As an example, the prediction model creating unit 12 creates three prediction models h1, h2 and h3 corresponding to three sub data B1, B2 and B3 of the first data D1, respectively, from the three sub data as shown in FIG. 2, and creates two prediction models h1 and h2 corresponding to sub data B1 and B2, respectively, from the sub data as shown in FIG. 5(5-1).

In a case where the first data D1 is decomposed into the sub data B with a weight given to the pair data of the first data D1 as described above, the prediction model creating unit 12 can create a prediction model hₖ corresponding to k^{th} sub data Bₖ by performing machine learning so as to minimize a loss function shown in Formula 4 below.

$${\sum }_{i = 1}^{{m}_{1}} {w}_{ki} ℓ ( {y}_{i} , {h}_{k} ( {x}_{i} ) ) \qquad [ Formula 4 ]$$

The above 1 may use, for example, logarithmic degree, squared error, cross-entropy loss, or the like.

Although the first data D1 is decomposed into the pieces of sub data B and a prediction model h corresponding to each piece of sub data B is created in the above description, the first data D1 and the pieces of sub data B and the prediction models h may be prepared and stored in the data storage unit 15 and the model storage unit 16. That is to say, the information processing apparatus 10 described above is not necessarily limited to including the data decomposing unit 11 and the prediction model creating unit 12, and the information processing apparatus may acquire the sub data B obtained by decomposing the first data D1 in advance and the prediction models h created in advance and, using the sub data B and the prediction models, perform generation and prediction of a gate model g as will be described later.

The gate model training unit 13 (generating unit) generates, by machine learning, a gate model g (second model) that outputs a model prediction value for predicting a prediction model h corresponding to an explanatory variable x in response to input of the explanatory variable x, using information representing the correspondence relation between the explanatory variables x of the first data D1 decomposed into a plurality of pieces of sub data B and prediction models h corresponding to the explanatory variables x, and stores the gate model into the model storage unit 16 (Step S4 of FIG. 6). Specifically, by using each of the sub data B obtained by decomposing the first data D1, the gate model training unit 13 first sets weight information representing a degree to which each of the explanatory variables x included in the sub data B corresponds to each of the prediction models h. At this time, focusing on only the explanatory variables x included in the sub data B, the gate model training unit sets weight information representing a degree to which the explanatory variable x corresponds to each of the prediction models h in accordance with which prediction model h the explanatory variable can apply, that is, which sub data B (cluster) the explanatory variable x can belong to.

A specific example of setting the weight information will be described with reference to FIG. 5(5-2). In FIG. 5(5-2), explanatory variables x located in a range x1 are included only in sub data B1, so that they may correspond to a prediction model h1 created from the sub data B1. Therefore, weight information for the explanatory variables x located in the range x1 is set to be 1.0 with respect to the prediction model h1 and 0.0 with respect to a prediction model h2, and is expressed as [1.0, 0.0]. Further, in FIG. 5(5-2), explanatory variables x located in a range x2 are included in both the sub data B1 and B2, so that they may correspond to both the prediction models h1 and h2 created from the sub data B1 and B2, respectively. Therefore, weight information for the explanatory variables x located in the range x2 is set to be 0.5 with respect to the prediction model h1 and 0.5 with respect to the prediction model h2, and is expressed as [0.5, 0.5]. Further, in FIG. 5(5-2), explanatory variables x located in a range x3 are included only in the sub data B2, so that they may correspond to the prediction model h2 created from the sub data B2. Therefore, weight information for the explanatory variables x located in the range x3 is set to be 0.0 with respect to the prediction model h1 and 1.0 with respect to the prediction model h2, and is expressed as [0.0, 1.0]. The example of setting the weight information described above is an example, and the weight information may be set based on the distribution of the explanatory variables x for the respective sub data B, such as being set to [0.3, 0.7].

In this manner, the weight information w is composed of the values of K weights wₖ in correspondence with the K prediction models h corresponding to the K pieces of sub data B and is expressed as [w₁, . . . , w_{K}]. In this example, wₖ, ≥0, w₁+ . . . +w_{K}=1, but any value may be set as a weight. In addition, in a case where only one prediction model h corresponds to each of the explanatory variables x, a weight wₖ corresponding to any of the prediction models hₖ can be set to 1 and otherwise 0.

Then, by using the explanatory variables x of the first data D1 and the weight information w set in correspondence with the explanatory variables x as described above as training data, the gate model training unit 13 performs machine learning on a gate model g that outputs weight information w corresponding to an input explanatory variable x. That is to say, by performing machine learning using training data with the explanatory variables x of the first data D1 as explanatory variables and the weight information w set in correspondence with the explanatory variables x as objective variables, the gate model training unit generates a gate model g that outputs a model prediction value g(x)=[w₁, . . . , wₖ] that is weight information in response to input of a new explanatory variable. In the example of FIG. 2, a gate model g is generated that predicts weight information w that is the correspondence degree of an explanatory variable x with respect to each of the three prediction models h1, h2, and h3.

Here, when setting the weight information w in correspondence with the explanatory variables x of the first data D1, the gate model training unit 13 may set the weight information w in such a manner that, for a prediction model h with a smaller prediction error with respect to the pair data of the first data D1, the degree of correspondence to the prediction model h, that is, the value of the weight is larger. For example, the gate model training unit 13 may set, with respect to certain pair data, the weight of a prediction model h with the smallest prediction error to 1.0 and otherwise 0.0. By performing machine learning as described above using the weight information w set in this manner, a gate model g is trained so that the weight of a prediction model h with the smallest prediction error is output large. To be more specific, a gate model g may be trained so as to minimize Formula 5 below using K pieces of sub data B.

$${\sum }_{k = 1}^{K} {\sum }_{i = 1}^{{m}_{1}} {w}_{ki} log {g ( {x}_{i} )}_{k} \qquad [ Formula 5 ]$$

In a case where the decomposition into the sub data B is performed with a weight given to pair data of the first data D1 as described above, the gate model training unit 13 may set the abovementioned weight information w in consideration of the weight given to such pair data, and train the gate model g using the weight information w. For example, in a case where the weight information w for the two prediction models h with respect to the explanatory variables x of the first data D1 within the range x2 is set to [0.5, 0.5] as shown in the example of FIG. 5(5-2) described above, when 0.7 and 0.3 are given as weights for the two sub data B to the first data D1, the weight information w may be set to [0.6, 0.4] in consideration of such weights.

The predicting unit 14 acquires second data including only a new explanatory variable x to be a target of prediction (Step S5 of FIG. 6), and performs prediction from the second data using the gate model g and the prediction models h generated as described above (Step S6 of FIG. 6). To be specific, the predicting unit 14 first acquires second data D2 including only a new explanatory variable x as indicated by Formula 6 below.

$${D}_{2} = {\{ {x}_{i} \}}_{i = 1}^{{m}_{3}} \qquad [ Formula 6 ]$$

Then, the predicting unit 14 inputs a new explanatory variable x that is the second data D2 into the gate model g, and obtains weight information w output from the gate model g. That is to say, the predicting unit 14 obtains a model prediction value g(x)=[w₁, . . . , wₖ] that is weight information w representing a degree to which the new explanatory variable x corresponds to each of the prediction models h. With such a model prediction value, it is possible to determine which prediction model h is used for prediction for the second data D2. That is to say, in prediction of a prediction value from the second data D2, it is possible to determine which prediction model h's prediction value should be given more importance in the prediction.

For example, the predicting unit 14 first inputs the second data D2 into all the prediction models h, and obtains prediction values that are outputs from the respective prediction models h. Then, the predicting unit 14 multiplies the prediction values from the respective prediction models h by the weights of the model prediction values corresponding to the respective prediction models h, and calculates the sum as a final prediction value. To be specific, the predicting unit calculates a prediction value yⱼ by Formula 7 below.

$${y}_{j} = {\sum }_{k = 1}^{K} {g ( x )}_{k} {h}_{k} ( x ) \qquad [ Formula 7 ]$$

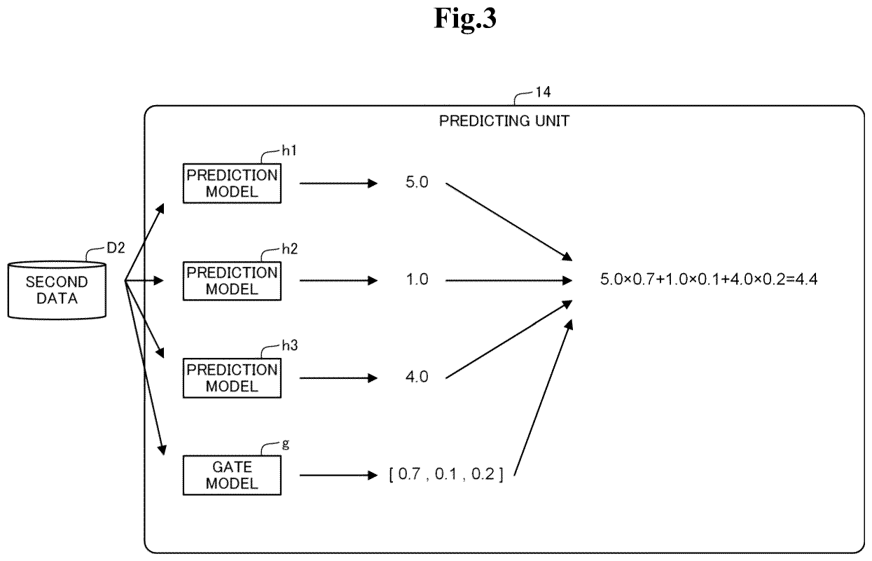

An example of calculation of a prediction value by the predicting unit 14 will be described with reference to FIG. 3. In this example, it is assumed that first data D1 is decomposed into three sub data B1, B2 and B3 and three prediction models h1, h2 and h3 are created in advance as shown in FIG. 2. First, the predicting unit 14 inputs a new explanatory variable x that is second data D2 into a gate model g and thereby obtains weight information w that is degrees to which the explanatory variable x corresponds to the respective prediction models h1, h2 and h3 as an output of the gate model g. In this example, g(x)=[0.7, 0.1, 0.2] can be obtained, and the explanatory variable x that is the second data D2 corresponds to the prediction model h1 with a weight 0.7, corresponds to the prediction model h2 with a weight 0.1, and corresponds to the prediction model h3 with a weight 0.2. In other words, the explanatory variable x that is the second data D2 is appropriate in order of the prediction models h1, h3 and h2. Subsequently, the predicting unit 14 inputs the new explanatory variable x that is the second data D2 into the respective prediction models h1, h2 and h3, and obtains prediction values that are outputs from the respective prediction models h1, h2 and h3. In this example, the predicting unit obtains a prediction value 5.0 by the prediction model h1, a prediction value 1.0 by the prediction model h2, and a prediction value 4.0 by the prediction model h3. Then, the predicting unit 14 multiplies the prediction values from the prediction models h1, h2 and h3 by the weights of the prediction models h1, h2 and h3, respectively, and calculates the sum. In this example, the predicting unit calculates as “5.0×0.7+1.0×0.1+4.0×0.2=4.4” and sets it as the final prediction value.

As described above, according to the information processing apparatus 10 according to the present disclosure, the prediction model h corresponding to each of the sub data B obtained by decomposing the first data D1 in accordance with the characteristic is created, and based on the degree of correspondence between the explanatory variable x of the first data D1 and the prediction model h, the gate model g that predicts the prediction model h from the explanatory variable x is generated through machine learning. This allows for the prediction of the prediction model h corresponding to a new explanatory variable x, and high-precision prediction can be achieved using a prediction model h with a high degree of correspondence to predict a prediction value for the new explanatory variable x. Furthermore, the gate model g can predict a degree to which an explanatory variable x corresponds to each of the prediction models h by a weight, and aggregate the prediction values by the prediction models h according to the weights to derive the final prediction value, thereby achieving further increase in prediction precision.

### MODIFIED EXAMPLE

Here, a modified example of the above information processing apparatus 10 will be described. The above gate model training unit 13 may receive input of third data D3 including a pair of explanatory variable x and objective variable y and train the gate model g using the third data D3 as shown in FIG. 1. At this time, the third data D3 is obtained from actual examples or generated from simulation, a probability model and the like, and is expressed by Formula 8, for example.

$${D}_{3} = {\{ ( {x}_{i} , {y}_{i} ) \}}_{i = 1}^{{m}_{3}} \qquad [ Formula 8 ]$$

To be specific, upon acquiring the third data D3, the gate model training unit 13 first causes the predicting unit 14 to perform prediction. The predicting unit 14 inputs the explanatory variable x of the third data D3 into the gate model g and the prediction models h as described above, and predicts a prediction value with respect to the explanatory variable x of the third data D3. Then, the gate model training unit 13 updates the gate model g by performing machine learning in such a manner as to minimize the error between the prediction value and the objective variable y paired with the explanatory variable x in the third data D3. For example, the gate model training unit trains the gate model g in such a manner as to minimize a loss function shown in Formula 9 below.

$${\sum }_{i = 1}^{{m}_{1}} ℓ ( {y}_{i} , {\sum }_{k = 1}^{K} {g ( {x}_{i} )}_{k} {h}_{k} ( {x}_{i} ) ) \qquad [ Formula 9 ]$$

Further, as another modified example, the above data decomposing unit 11 may decompose the first data D1 using the result of prediction by the predicting unit 14. To be specific, first, the predicting unit 14 inputs the explanatory variable x of the first data D1 into the gate model g and the respective prediction models h as described above and predicts a prediction value with respect to the explanatory variable x of the first data D1. Then, the data decomposing unit 11 decomposes the first data D1 into the sub data B again based on the error between the prediction value and the objective variable y paired with the explanatory variable x in the first data D1 and, in the same manner as described above, repeatedly performs creation of the prediction model h of each of the sub data B and training of the gate model g. At this time, for example, the data decomposing unit 11 decomposes the first data D1 in such a manner as to minimize the error between the prediction value and the objective variable, or allocates and decomposes the first data D1 to sub data corresponding to the prediction model h with the smallest error of the prediction value by each of the prediction models h.

### USAGE EXAMPLE

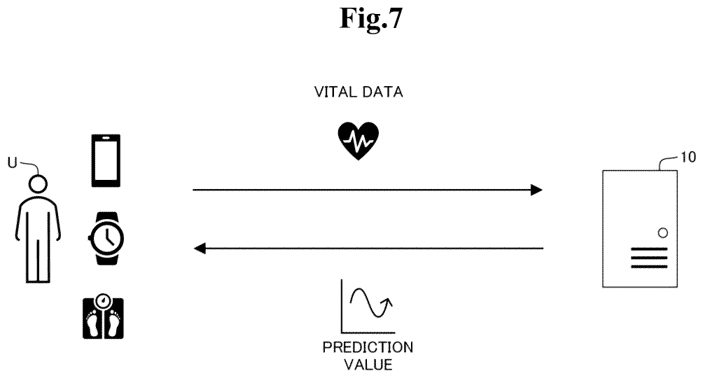

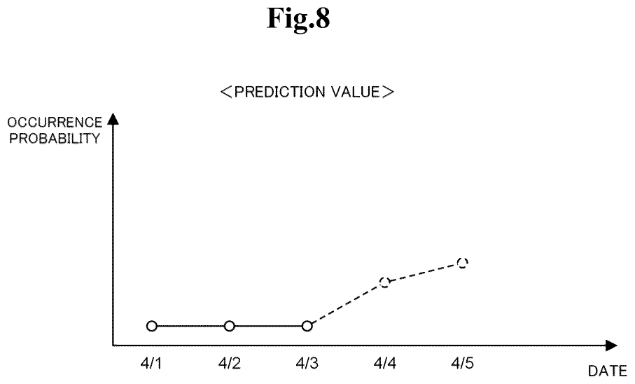

Next, a usage example of the present disclosure will be described. Here, as mentioned above, a case of predicting the probability of occurrence of an attack that is a patient's disease will described as an example. First, as shown in FIG. 7, a patient U measures vital data such as body temperature and heart rate using a wearable terminal that the patient is wearing and a measurement device, and inputs such vital data as input data (explanatory variable x) into the information processing apparatus 10 via an information processing terminal. At this time, environmental information such as temperature and weather may be input as the input data (explanatory variable x) in addition to the vital data into the information processing apparatus 10. Then, the information processing apparatus 10 predicts the occurrence probability of the patient's attack using the prediction models h and the gate model g generated as described above. Furthermore, the information processing apparatus 10 outputs the predicted occurrence probability to the patient U. For example, the information processing apparatus outputs in such a manner as to display a screen showing the prediction of the occurrence probability for each date as shown in FIG. 8 on the information processing terminal of the patient U. The usage example of the information processing apparatus 10 described above is an example, and it may be used for any prediction.

### Second Example Embodiment

Next, a second example embodiment of the present disclosure will be described with reference to the drawings. This example embodiment shows the overview of the information processing apparatus and so forth described in the above example embodiment. The drawings may be related to any of the example embodiments.

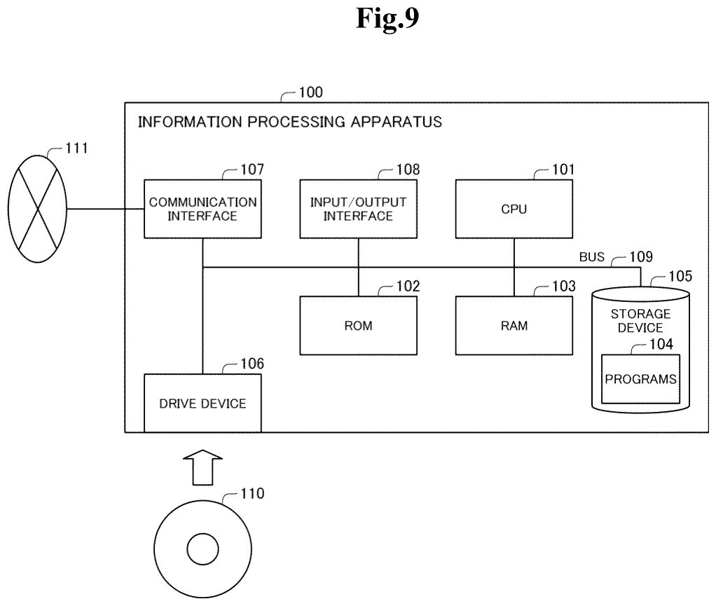

First, a hardware configuration of an information processing apparatus 100 in the present disclosure will be described. The information processing apparatus 100 is configured with a general information processing apparatus and, as an example, as shown in FIG. 9, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 9 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

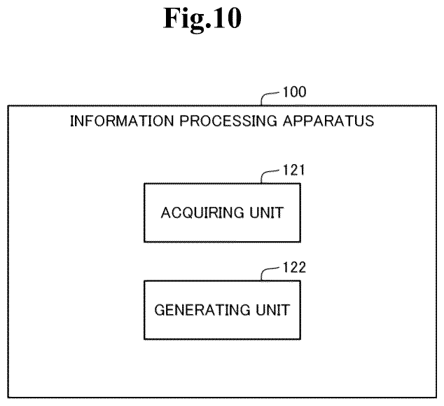

Then, the information processing apparatus 100 can construct and include an acquiring unit 121 and a generating unit 122 shown in FIG. 10 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the acquiring unit 121 and the generating unit 122 described above may be constructed using a dedicated electronic circuit for realizing such means.

The acquiring unit 121 acquires first data composed of pairs of explanatory variables and objective variables classified into a plurality of classifications based on a correspondence relation between the explanatory variable and the objective variable, and a first model generated in such a manner as to predict the objective variable from the explanatory variable based on the first data for each of the classifications. The generating unit 122 generates a second model that predicts the first model corresponding to the explanatory variable based on information representing a correspondence relation between the explanatory variable of the first data and the first model based on the classification.

With the configuration as described above, the present disclosure can predict the first model corresponding to a new explanatory variable using the second model, and predict a prediction value with respect to the new explanatory variable using the predicted first model. As a result, it is possible to achieve increase of the precision of prediction using a machine learning model.

At least one or more functions of the functions of the acquiring unit 121 and the generating unit 122 described above may be executed by an information processing apparatus installed and connected anywhere on the network, that is, may be executed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### SUPPLEMENTARY NOTES

The whole or part of the example embodiments disclosed above can be described as the following supplementary notes. Hereinafter, the overview of configurations of an information processing apparatus, an information processing method, and a program in the present disclosure will be described. However, the present disclosure is not limited to the configurations described in the following supplementary notes.

All or some of the configurations described in Supplementary Notes 2 to 8.2 dependent on Supplementary Note 1 described below and the functions by such configurations may be dependent on other Supplementary Notes 9 and 10 by the same dependence as Supplementary Notes 2 to 8.2. Furthermore, not limited to Supplementary Notes 1, 9, or 10, within the scope of the example embodiments described above, all or some of the configurations described as supplementary notes and functions by such configurations may be dependent on hardware, software, various recording means for recording software, or system.

### Supplementary Note 1

An information processing apparatus comprising:
an acquiring unit configured to acquire first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and
a generating unit configured to generate a second model in accordance with information representing a correspondence relation between the explanatory variable of the first data based on the classification and the first model, the second model predicting the first model corresponding to the explanatory variable.

### Supplementary Note 2

The information processing apparatus according to supplementary note 1, further comprising
a predicting unit configured to, by using the first model corresponding to a second explanatory variable predicted by inputting the second explanatory variable into the second model, predict a prediction value from the second explanatory variable.

### Supplementary Note 3

The information processing apparatus according to supplementary note 1, wherein
the generating unit is configured to, in accordance with weight information representing a degree to which the explanatory variable of the first data based on the classification corresponds to each of the first models, generate the second model that predicts the first model corresponding to the explanatory variable.

### Supplementary Note 4

The information processing apparatus according to supplementary note 3, wherein
the generating unit is configured to generate the second model that predicts the degree to which the explanatory variable corresponds to each of the first models.

### Supplementary Note 5

The information processing apparatus according to supplementary note 3, wherein
the generating unit is configured to generate the second model by setting the weight information in such a manner that, as the first model has a smaller prediction error with respect to the first data, the degree to which the explanatory variable corresponds to the first model is higher.

### Supplementary Note 6

The information processing apparatus according to supplementary note 4, further comprising
a predicting unit configured to input a second explanatory variable into the second model and predict a degree to which the second explanatory variable corresponds to each of the first models and, by using the first model in accordance with the predicted degree, predict a prediction value from the second explanatory variable.

### Supplementary Note 7

The information processing apparatus according to supplementary note 1, further comprising
a predicting unit configured to, by using the first model corresponding to a third explanatory variable predicted by inputting the third explanatory variable into the second model, predict a prediction value from the third explanatory variable, wherein
the generating unit is configured to generate the second model in such a manner that an error between the prediction value predicted from the third explanatory variable and a third objective variable paired in advance with the third explanatory variable is smaller.

### Supplementary Note 8

The information processing apparatus according to supplementary note 1, further comprising:
a classifying unit configured to classify the first data into the plurality of classifications in accordance with the correspondence relation between the explanatory variable and the objective variable;
a first model generating unit configured to generate the first model that predicts the objective variable from the explanatory variable based on the first data for each of the classifications; and
a predicting unit configured to, by using the first model corresponding to the explanatory variable of the first data predicted by inputting the explanatory variable into the second model, predict a prediction value from the explanatory variable, wherein
the classifying unit is configured to classify the first data into the plurality of classifications based on an error between the prediction value predicted from the explanatory variable of the first data and the objective variable corresponding to the explanatory variable.

### Supplementary Note 8.1

The information processing apparatus according to supplementary note 1, further comprising:
a classifying unit configured to classify the first data into the plurality of classifications in accordance with the correspondence relation between the explanatory variable and the objective variable, and give a weight to the first data based on the classification; and
a first model generation unit configured to generate the first model that predicts the objective variable from the explanatory variable based on the first data and the weight given to the first data for each of the classifications.

### Supplementary Note 8.2

The information processing apparatus according to supplementary note 1, further comprising
a classifying unit configured to classify the first data into the plurality of classifications in accordance with the correspondence relation between the explanatory variable and the objective variable, and give a weight to the first data based on the classification, wherein
the generating unit is configured to generate the second model in accordance with the information representing the correspondence relation between the explanatory variable of the first data and the first model based on the classification and with the weight given to the first data.

### Supplementary Note 9

An information processing method comprising:
acquiring first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and
generating a second model in accordance with information representing a correspondence relation between the explanatory variable of the first data based on the classification and the first model, the second model predicting the first model corresponding to the explanatory variable.

### Supplementary Note 9.1

The information processing method according to supplementary note 9, comprising
by using the first model corresponding to a second explanatory variable predicted by inputting the second explanatory variable into the second model, predicting a prediction value from the second explanatory variable.

### Supplementary Note 9.2

The information processing method according to supplementary note 9, comprising
in accordance with weight information representing a degree to which the explanatory variable of the first data based on the classification corresponds to each of the first models, generating the second model that predicts the first model corresponding to the explanatory variable.

### Supplementary Note 9.3

The information processing method according to supplementary note 9.2, comprising
generating the second model that predicts the degree to which the explanatory variable corresponds to each of the first models.

### Supplementary Note 9.4

The information processing method according to supplementary note 9.2, comprising
generating the second model by setting the weight information in such a manner that, as the first model has a smaller prediction error with respect to the first data, the degree to which the explanatory variable corresponds to the first model is higher.

### Supplementary Note 9.5

The information processing method according to supplementary note 9.3, comprising
inputting a second explanatory variable into the second model and predicting a degree to which the second explanatory variable corresponds to each of the first models and, by using the first model in accordance with the predicted degree, predicting a prediction value from the second explanatory variable.

### Supplementary Note 9.6

The information processing method according to supplementary note 9, comprising:
by using the first model corresponding to a third explanatory variable predicted by inputting the third explanatory variable into the second model, predicting a prediction value from the third explanatory variable; and
generating the second model in such a manner that an error between the prediction value predicted from the third explanatory variable and a third objective variable paired in advance with the third explanatory variable is smaller.

### Supplementary Note 9.7

The information processing method according to supplementary note 9, comprising:
classifying the first data into the plurality of classifications in accordance with the correspondence relation between the explanatory variable and the objective variable;
generating the first model that predicts the objective variable from the explanatory variable based on the first data for each of the classifications; and
by using the first model corresponding to the explanatory variable of the first data predicted by inputting the explanatory variable into the second model, predicting a prediction value from the explanatory variable; and further
classifying the first data into the plurality of classifications based on an error between the prediction value predicted from the explanatory variable of the first data and the objective variable corresponding to the explanatory variable.

### Supplementary Note 10

A program comprising instructions for causing a computer to execute processes to:
acquire first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and
generate a second model in accordance with information representing a correspondence relation between the explanatory variable of the first data based on the classification and the first model, the second model predicting the first model corresponding to the explanatory variable.

### REFERENCE SIGNS LIST

10 information processing apparatus
11 data decomposing unit
12 prediction model creating unit
13 gate model training unit
14 predicting unit
15 data storage unit
16 model storage unit
100 information processing apparatus
101 CPU
102 ROM
103 RAM
104 programs
10 storage device
106 drive device
107 communication interface
108 input/output interface
109 bus
110 storage medium
111 communication network
121 acquiring unit
122 generating unit

1. An information processing apparatus comprising:
at least one memory storing processing instructions; and
at least one processor configured to execute the processing instructions to:
acquire first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and
generate a second model in accordance with information representing a correspondence relation between the explanatory variable of the first data based on the classification and the first model, the second model predicting the first model corresponding to the explanatory variable.

2. The information processing apparatus according to claim 1, wherein the at least one processor is configured to execute the processing instructions to
by using the first model corresponding to a second explanatory variable predicted by inputting the second explanatory variable into the second model, predict a prediction value from the second explanatory variable.

3. The information processing apparatus according to claim 1, wherein the at least one processor is configured to execute the processing instructions to
in accordance with weight information representing a degree to which the explanatory variable of the first data based on the classification corresponds to each of the first models, generate the second model that predicts the first model corresponding to the explanatory variable.

4. The information processing apparatus according to claim 3, wherein the at least one processor is configured to execute the processing instructions to
generate the second model that predicts the degree to which the explanatory variable corresponds to each of the first models.

5. The information processing apparatus according to claim 3, wherein the at least one processor is configured to execute the processing instructions to
generate the second model by setting the weight information in such a manner that, as the first model has a smaller prediction error with respect to the first data, the degree to which the explanatory variable corresponds to the first model is higher.

6. The information processing apparatus according to claim 4, wherein the at least one processor is configured to execute the processing instructions to
input a second explanatory variable into the second model and predict a degree to which the second explanatory variable corresponds to each of the first models and, by using the first model in accordance with the predicted degree, predict a prediction value from the second explanatory variable.

7. The information processing apparatus according to claim 1, wherein the at least one processor is configured to execute the processing instructions to:
by using the first model corresponding to a third explanatory variable predicted by inputting the third explanatory variable into the second model, predict a prediction value from the third explanatory variable; and
generate the second model in such a manner that an error between the prediction value predicted from the third explanatory variable and a third objective variable paired in advance with the third explanatory variable is smaller.

8. The information processing apparatus according to claim 1, wherein the at least one processor is configured to execute the processing instructions to:
classify the first data into the plurality of classifications in accordance with the correspondence relation between the explanatory variable and the objective variable;
generate the first model that predicts the objective variable from the explanatory variable based on the first data for each of the classifications;
by using the first model corresponding to the explanatory variable of the first data predicted by inputting the explanatory variable into the second model, predict a prediction value from the explanatory variable; and further
classify the first data into the plurality of classifications based on an error between the prediction value predicted from the explanatory variable of the first data and the objective variable corresponding to the explanatory variable.

9. The information processing apparatus according to claim 1, wherein the at least one processor is configured to execute the processing instructions to:
classify the first data into the plurality of classifications in accordance with the correspondence relation between the explanatory variable and the objective variable, and give a weight to the first data based on the classification; and
generate the first model that predicts the objective variable from the explanatory variable based on the first data and the weight given to the first data for each of the classifications.

10. The information processing apparatus according to claim 1, wherein the at least one processor is configured to execute the processing instructions to:
classify the first data into the plurality of classifications in accordance with the correspondence relation between the explanatory variable and the objective variable, and give a weight to the first data based on the classification; and
generate the second model in accordance with the information representing the correspondence relation between the explanatory variable of the first data and the first model based on the classification and with the weight given to the first data.

11. An information processing method comprising:
acquiring first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and
generating a second model in accordance with information representing a correspondence relation between the explanatory variable of the first data based on the classification and the first model, the second model predicting the first model corresponding to the explanatory variable.

12. The information processing method according to claim 11, comprising
by using the first model corresponding to a second explanatory variable predicted by inputting the second explanatory variable into the second model, predicting a prediction value from the second explanatory variable.

13. The information processing method according to claim 11, comprising
in accordance with weight information representing a degree to which the explanatory variable of the first data based on the classification corresponds to each of the first models, generating the second model that predicts the first model corresponding to the explanatory variable.

14. The information processing method according to claim 13, comprising
generating the second model that predicts the degree to which the explanatory variable corresponds to each of the first models.

15. The information processing method according to claim 13, comprising
generating the second model by setting the weight information in such a manner that, as the first model has a smaller prediction error with respect to the first data, the degree to which the explanatory variable corresponds to the first model is higher.

16. The information processing method according to claim 14, comprising
inputting a second explanatory variable into the second model and predicting a degree to which the second explanatory variable corresponds to each of the first models and, by using the first model in accordance with the predicted degree, predicting a prediction value from the second explanatory variable.

17. The information processing method according to claim 11, comprising:
by using the first model corresponding to a third explanatory variable predicted by inputting the third explanatory variable into the second model, predicting a prediction value from the third explanatory variable; and
generating the second model in such a manner that an error between the prediction value predicted from the third explanatory variable and a third objective variable paired in advance with the third explanatory variable is smaller.

18. The information processing method according to claim 11, comprising:
classifying the first data into the plurality of classifications in accordance with the correspondence relation between the explanatory variable and the objective variable;
generating the first model that predicts the objective variable from the explanatory variable based on the first data for each of the classifications;
by using the first model corresponding to the explanatory variable of the first data predicted by inputting the explanatory variable into the second model, predicting a prediction value from the explanatory variable; and further
classifying the first data into the plurality of classifications based on an error between the prediction value predicted from the explanatory variable of the first data and the objective variable corresponding to the explanatory variable.

19. A non-transitory computer-readable storage medium storing a program, the program comprising instructions for causing a computer to execute processes to:
acquire first data and first models, the first data being composed of pairs of explanatory variables and objective variables classified into a plurality of classifications in accordance with a correspondence relation between the explanatory variable and the objective variable, each of the first models being generated in such a manner as to predict the objective variable from the explanatory variable based on the first data for each of the classifications; and
generate a second model in accordance with information representing a correspondence relation between the explanatory variable of the first data based on the classification and the first model, the second model predicting the first model corresponding to the explanatory variable.
